(19) United States
(12) Patent Application Publication
(10) Pub. No.: US 2008/0196311 A1
(43) Pub. Date: Aug. 21, 2008

(54) Articulated Mounting System for Doors with Limited Space

(76) Inventor: Emilio Ruso Sobra, Sevilla (ES)

Correspondence Address: LUCAS & MERCANTI, LLP, 475 PARK AVENUE SOUTH, 15TH FLOOR, NEW YORK, NY, 10016, US

(21) Appl. No.: 11/677,445

(22) Filed: Feb. 21, 2007

(51) Int. Cl. E05D 15/10

(52) U.S. Cl. 49/209

(57) ABSTRACT

This invention consists of an “articulated mounting system for doors with limited space” that consists of introducing, between a conventional door and the frame or surface to be covered, a solid intermediary provided with angular displacement around a resting axis located in the frame, wall or any surface that supports the door and which, at its other end, contains the turning axis for the door located on its own symmetrical axis, incorporating a horizontal handle in the turning axis of the door itself and around one of its faces, which allows the user to force the movement of the whole thing and to move it in a parallel fashion to the surface of the door until they can enter or exit without difficulty.

In short, this descriptive report refers to a double articulation for doors or mobile surfaces, made up of two parallel turning axes displaced by a distance equal to half of the surface to be covered.

Thus, the articulation, the object of this invention, is carried out by means of four hinges that add, to the doors in which they are affixed, a second turning axis parallel to the first, although displaced a certain distance from the frame.

The field of application for this invention is the door manufacturing industry.

Revising the status of technology in this subject, throughout time, several solutions have been offered for the design, production and assembly of doors, when space is limited in the place where they will be installed; for example, doors in two sections or accordion doors.

A multitude of applications exist in which the space available to house a door is very limited. Thus, the “articulated mounting system for doors with limited space” offers the following advantages with regards to the status of technology:
It is possible to install it in small areas or those with little space without the need to divide the door to occupy half of its width,
It can incorporate any wanted design,
It is easy to clean, as there are no hidden corners,
It fulfils all the requirements for accessibility, and
It can be easily adapted for people with disabilities.

Thus, the “articulated mounting system for doors with limited space” is carried out by introducing a solid intermediary, between a conventional door and the frame or surface to be covered, provided with angular displacement around a resting located in the frame, wall or any surface that can support the door and which, at its other end, contains the turning axis for the door located on its own symmetrical axis, and which also has a correction displacement for lack of evenness or symmetry.

Thus, the solid or articulate arm describes from its resting position an inwards movement of 90° and an outwards movement of 90°, a total of 180°, and introduces a new movement when moved angularly on its resting end, while the door, in any hinge or solid intermediary position, can rotate up to 180° on its symmetrical axis around itself.

This invention can also incorporate several systems, such as locks, stoppers, handles, catches, alignment systems and guides, according to the installation requirements.

In the central part of the door of the system incorporates an extensible piston that it allows us to regulate horizontally to compensate the differences simultaneously that serves in order that the above mentioned system is modular.

The hinges take a few elements to incorporate them in its central base for the alignment of the pieces and that allows to raise the leaf to avoid frets in the low rubbers (gums).

In its central hinge that is taken caught to the central zone of the door it has a regulation in vertically.

It contains a hinge in the wings that supports the weight of the leaf. This hinge is taken both to wall and to a fixed lateral piece already be of glass or aluminium, and it consists of a cookie with regulation in vertically, with two interchangeable orifices in order that the system is to right and left side changing the position of the drills.

With the object of demonstrating the invention “articulated mounting system for doors with limited space,” below can be seen some figures in which the invention described is represented in a practical way on a shower screen, such as that which is frequently used in bathrooms.

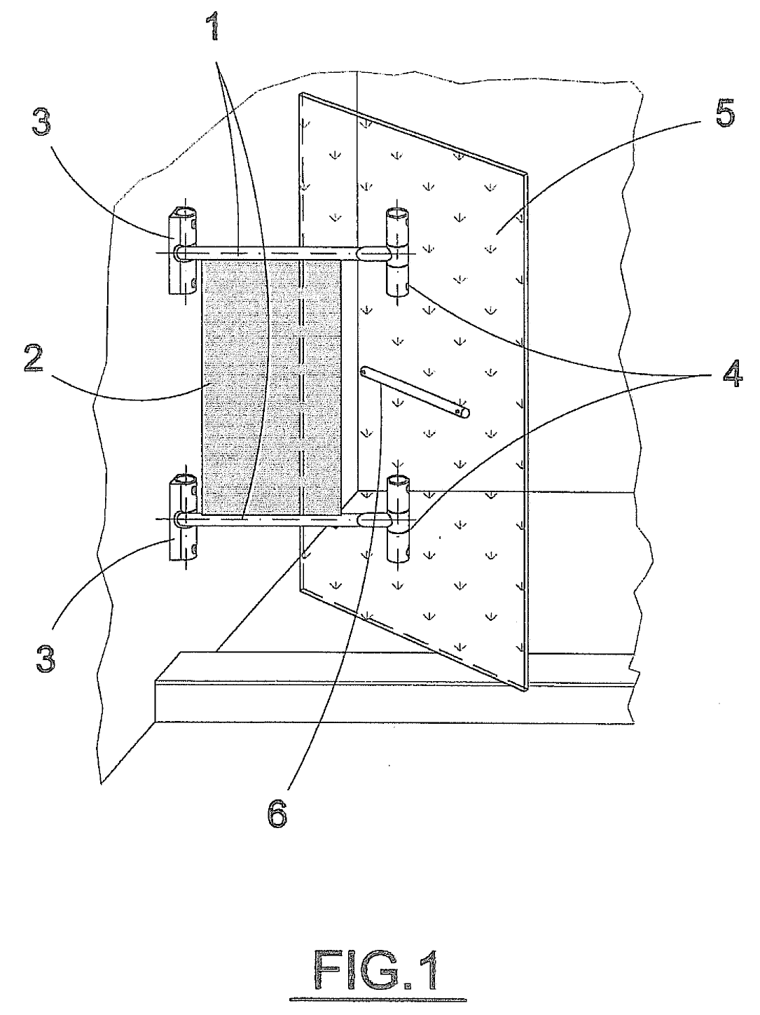

FIG. 1: “Articulated mounting system for doors with limited space” applied to a shower screen.

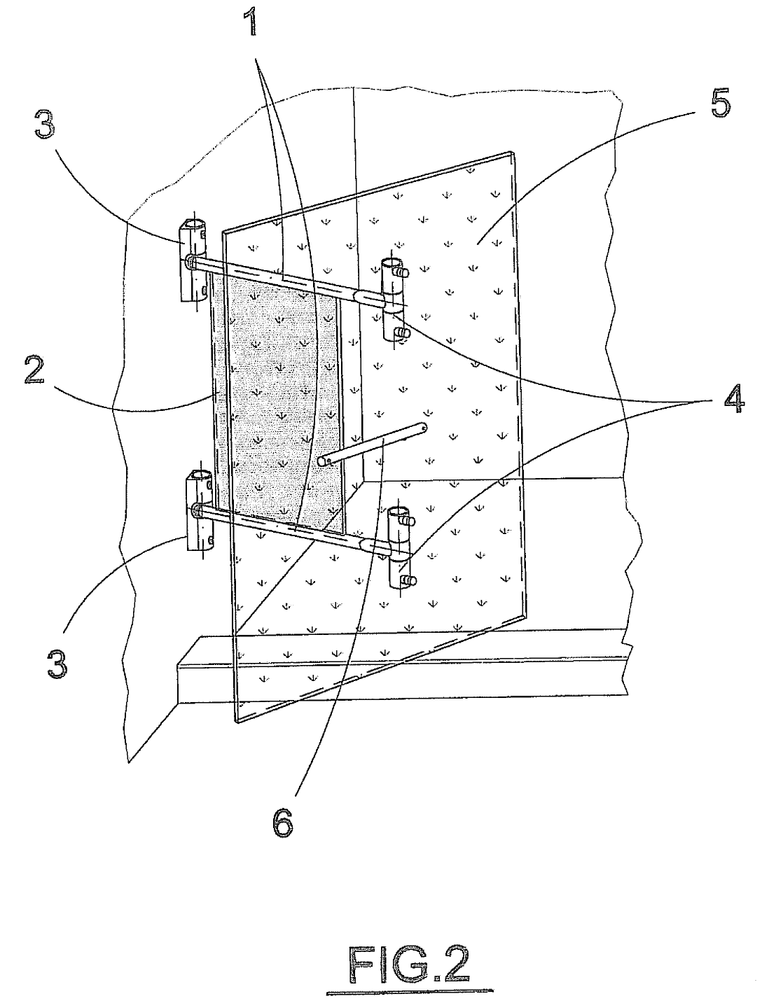

FIG. 2: “Articulated mounting system for doors with limited space” applied to a shower screen, viewed from behind.

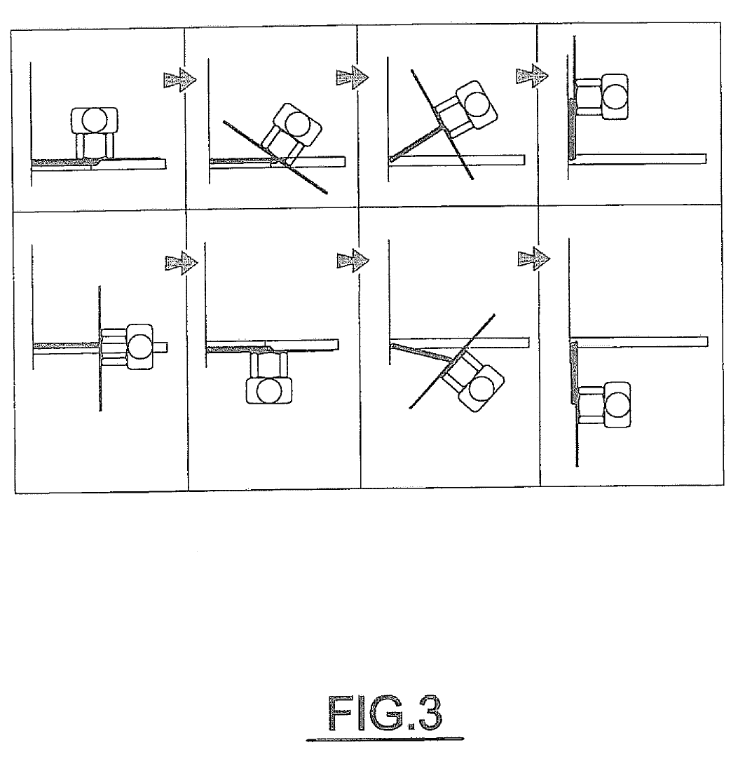

FIG. 3: Movement Scheme of “Articulated mounting system for doors with limited space”.

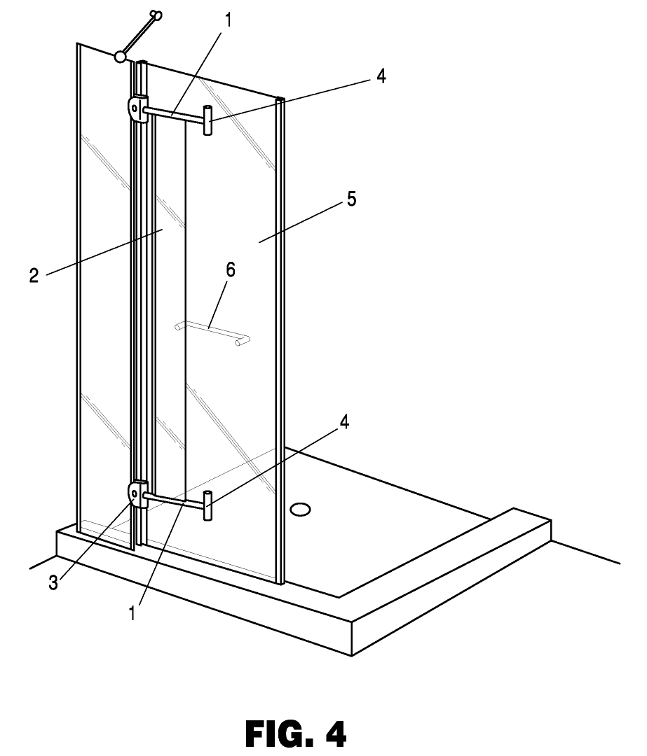

FIG. 4: “Articulated mounting system for doors with limited space” applied to a shower screen, with hinge.

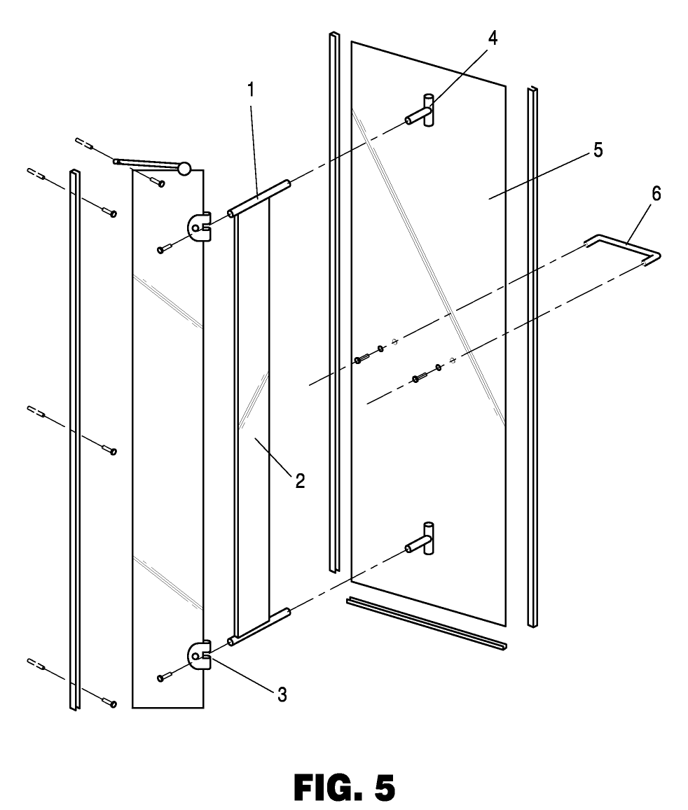

FIG. 5: “Articulated mounting system for doors with limited space” applied to a shower screen, viewed as assembly (montage).

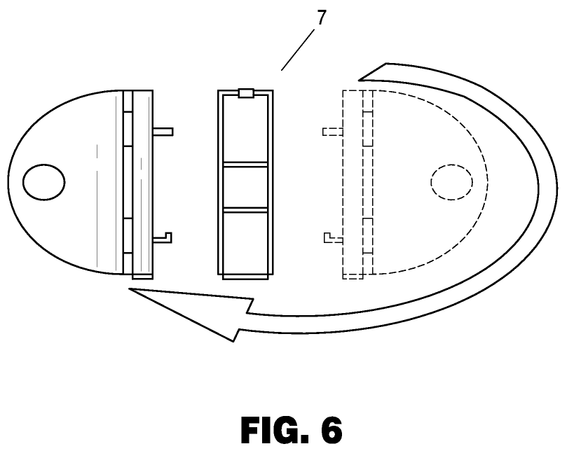

FIG. 6: Hinge.

In these figures, the key to the numbered elements is as follows:

(1): Two arms articulated at their ends.
(2): Rigid joint element between the two arms.
(3): Turning axis on the wall at rest.
(4): Turning axis of the screen, and extensible piston.

### (5): Screen.

(6): Lever bar element or handle for the manipulation of the screen.

### (7): Hinge.

Looking at the figures, one can see a realization of the invention that is the object of the current document, an “articulated mounting system for doors with limited space,” that has been applied to a shower screen consisting of two arms (1) joined by means of a rigid element (2) and provided with angular displacement by means of the necessary elements, such as alignment elements at rest, around the turning axis (3) located fixed in the wall, while the ends of the arms (1) furthest from the fixed wall constitute the turning axis (4) about which the screen turns (5) around its symmetrical axis.

Just as is demonstrated in FIG. 3 by means of the horizontal handle (6) located perpendicular to the turning axis of the screen (4), on one face of this, the user can force the movement of the screen (5), moving it parallel to its surface until they can enter or leave without difficulty.

A more extensive description is not considered necessary for any expert in this field to understand the reach of the invention and the advantages that are derived from it. The material, shape, size, number and disposition of the elements that are described can be varied, provided that this does not suppose an alteration to the essence of the invention.

What is claimed is:

1. Articulated mounting system for doors with limited space, characterized as consisting of a solid intermediary (1 and 2) that forms the joint between the door (5) and the frame or wall, provided with angular displacement around an axis at rest (3), located in the door frame (5) or surface of the wall and which, at the end furthest from the axis at rest (3), contains the turning axis of the door (4), coinciding with its symmetrical axis.

2. Articulated mounting system for doors with limited space, according to claim 1, is characterized by the fact that the door, (5) upon which the one who installs it must incorporate a horizontal handle (6) located in the door's own turning axis (4) and on one of its faces, which enables the user to force the movement of the whole thing (1, 2 and 5) and to move it in a parallel fashion to the surface of the door (5) until they can enter or exit without difficulty.

3. Articulated mounting system for doors with limited space, according to claim 1, characterized by its ability to be alternatively mounted in a way similar to two-part doors.

4. Articulated mounting system for doors with limited space, according to claim 2, characterized by its ability to be alternatively mounted in a way similar to two-part doors.
